(19) United States
(12) Patent Application Publication
(10) Pub. No.: US 2026/0001710 A1
(43) Pub. Date: Jan. 1, 2026

(54) CAULK PORT FOR A TWO-PIECE TANK

(71) Applicant: Advanced Drainage Systems, Inc., Hilliard, OH (US)

(72) Inventor: Paul HOLBROOK, Old Saybrook, CT (US)

(73) Assignee: Advanced Drainage Systems, Inc., Hilliard, OH (US)

(21) Appl. No.: 19/251,951

(22) Filed: Jun. 27, 2025

Related U.S. Application Data
(60) Provisional application No. 63/665,505, filed on Jun. 28, 2024.

(51) Int. Cl. B65D 90/08; B65D 88/02; C02F 1/40; C02F 101/32; C02F 103/32

(52) U.S. Cl. CPC B65D 90/08; B65D 88/02; C02F 1/40; C02F 2101/32; C02F 2103/32; C02F 2201/004

(57) ABSTRACT

Methods, systems, and apparatuses for a caulk port for a two-piece tank are disclosed. A tank may include an upper half tank comprising an upper caulk port and a lower half tank comprising a lower caulk port, wherein the upper half tank and the lower half tank are mated at a joint; a baffle gasket located at an inner wall of the upper half tank and an inner wall of the lower half tank; and a tank gasket located at the joint between the upper half tank and the lower half tank. The upper caulk port or the lower caulk port may be configured to receive a sealant to seal the baffle gasket and the tank gasket.

### RELATED APPLICATION DATA

This application claims priority to pending U.S. Provisional Patent Application No. 63/665,505 filed on Jun. 28, 2024, titled CAULK PORT FOR A TWO-PIECE TANK, the entire disclosure of which is incorporated herein by reference.

### TECHNICAL FIELD

This disclosure relates generally to systems, methods, and apparatuses for providing a watertight connection between two chambers of a two-piece tank, and more particularly, for providing a watertight connection through a caulk port.

### BACKGROUND

Wastewater management systems, such as grease interceptor systems, process wastewater to remove contaminants such as fats, oils, and grease. These systems may be used to separate contaminants from wastewater discharge flowing from wastewater sources, such as kitchen or food service waste streams. These systems temporarily store and divert wastewater streams for removal of contaminants before discharging filtered wastewater into municipal sewer systems or septic tanks.

In operation, grease interceptors, or other wastewater management systems, may comprise a corrugated tank assembled from two identical half tanks having a flange that may be mated at a joint. A baffle may be installed in the corrugations of the tank to nominally divide the length of the tank into two chambers, a first chamber and a second chamber, typically of equal size. During grease interceptor operation, there may be a net downstream flow of wastewater through the grease interceptor system. The baffle may impede the flow of contaminants from the first chamber into the second chamber, which may allow contaminants to settle from the flow of wastewater in the first chamber and the second chamber.

In some applications, a baffle gasket and a tank gasket may be provided to create a watertight seal to prevent wastewater from leaking from the first chamber into the second chamber or from leaking out of the tank. The baffle gasket may be provided at the seam between the baffle and the inner wall of the tank to prevent wastewater from leaking between the first chamber and the second chamber. The main tank gasket may be provided at the joint between the upper half tank and the lower half tank to prevent wastewater from leaking out of the tank. Caulk or other sealants may be applied around the seam between the tank gasket and the baffle gasket to further prevent wastewater from leaking through the seam.

Current techniques for providing a watertight seal between the first chamber and the second chamber of a tank may include applying a caulk or other sealant between the baffle gasket and the main tank gasket prior to fully assembling the tank. For example, current techniques may apply the caulk or sealant to the baffle and a lower half tank prior to placing the upper half tank over the baffle and the lower half tank. However, this process may be messy and may lead to leaks around the seam of the gaskets if the caulk or sealant is not evenly and consistently applied. Therefore, solutions are needed to provide a clean, simple, and reliable application of caulk at the seam between the main tank gasket and the baffle gasket.

### SUMMARY

The disclosed embodiments describe systems, methods, and devices for providing a watertight seal in a two-piece tank. These systems, methods, and devices may include a tank comprising an upper half tank, which may comprise an upper caulk port, and a lower half tank, which may comprise a lower caulk port, wherein the upper half tank and the lower half tank may be mated at a joint, a baffle gasket located at an inner wall of the upper half tank and an inner wall of the lower half tank, a tank gasket located at the joint between the upper half tank and the lower half tank, and wherein the upper caulk port may be configured to receive a sealant to seal the baffle gasket and the tank gasket.

In other embodiments, these systems, methods, and devices may include a tank comprising an upper half tank, which may comprise a caulk port, and a lower half tank, wherein the upper half tank and the lower half tank may be mated at a joint, a baffle gasket located at an inner wall of the upper half tank and an inner wall of the lower half tank, a tank gasket located at the joint between the upper half tank and the lower half tank, and wherein the caulk port may be configured to receive a sealant to seal the baffle gasket and the tank gasket.

### BRIEF DESCRIPTION OF THE DRAWINGS

The accompanying drawings constitute a part of this specification. The drawings illustrate several embodiments of the present disclosure and, together with the description, serve to explain the principles of the disclosed embodiments.

FIG. 1 depicts an as-molded caulk port in a wastewater management tank, according to disclosed embodiments.

FIG. 2 depicts a caulk port in a wastewater management tank after a hole has been drilled through the caulk port, according to disclosed embodiments.

FIG. 3 depicts caulk applied through the caulk port of a wastewater management tank, according to disclosed embodiments.

### DETAILED DESCRIPTION

Examples of embodiments of the present disclosure are described with reference to the accompanying drawings. In the figures, which are not necessarily drawn to scale, wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items or meant to be limited to only the listed item or items. It should also be noted that as used in the present disclosure and in the appended claims, the singular forms “a,” “an,” and “the” include plural references unless the context clearly dictates otherwise.

The disclosed embodiments improve deficiencies in existing techniques for applying caulk or other sealants to a baffle gasket and a main tank gasket. The disclosed embodiments provide a caulk port in a wastewater management tank, which may facilitate the application of caulk to the seam between the baffle gasket and the main tank gasket to create a watertight seal between the first chamber and the second chamber of the tank and between the upper half tank and the lower half tank. The disclosed embodiments allow for a clean, simple, and reliable application of caulk to the seam between a baffle gasket and a main tank gasket.

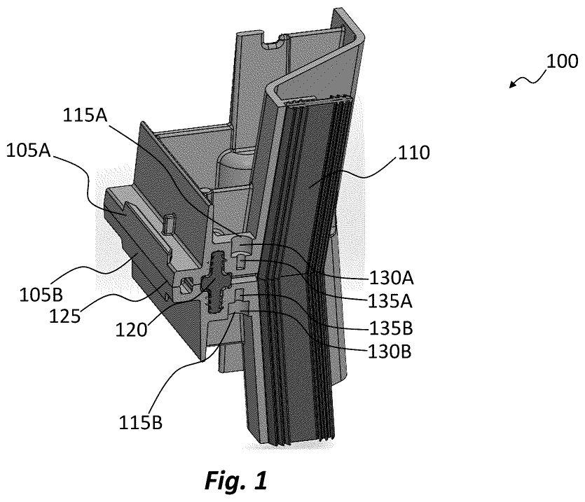

FIG. 1 depicts a section cut of a wastewater management tank 100. Wastewater management tank 100 may be formed by upper half tank 105A and lower half tank 105B. In some embodiments, upper half tank 105A and lower half tank 105B may be identical. In other embodiments, upper half tank 105A and lower half tank 105B may not be identical. In some embodiments, upper half tank 105A and lower half tank 105B may be made of molded polypropylene or polyethylene components. In other embodiments, upper half tank 105A and lower half tank 105B may alternatively comprise a material other than polypropylene or polyethylene; for instance, other polymers, fiberglass reinforced polyester resin, or concrete. Upper half tank 105A and lower half tank 105B may be mated at joint 125 by clamping, welding, adhesives, or any method of connection suitable for connecting upper half tank 105A and lower half tank 105B at joint 125 to form wastewater management tank 100. A baffle (not shown) may be installed within the corrugations of upper half tank 105A and lower half tank 105B to divide wastewater management tank 100 into a first chamber and a second chamber. Dividing wastewater management tank 100 into a first chamber and a second chamber may facilitate settlement of contaminants from the flow of wastewater within the first chamber and the second chamber.

Wastewater management tank 100 may further include baffle gasket 110 and tank gasket 120. Baffle gasket 110 may be installed at an inner wall of wastewater management tank 100, adjacent to the baffle (not shown). Tank gasket 120 may be installed at joint 125 between upper half tank 105A and lower half tank 105B. Baffle gasket 110 and tank gasket 120 may each comprise a mechanical seal that may prevent leakage of wastewater at the seams between the baffle and wastewater management tank 100 and between upper half tank 105A and lower half tank 105B. Baffle gasket 110 and tank gasket 120 may each be made of a rubber or elastomer material and may impede the flow of water between the first chamber and the second chamber of wastewater management tank 100 and between joint 125.

Upper half tank 105A may further comprise upper caulk port 115A and lower half tank 105B may further comprise lower caulk port 115B. In some embodiments, upper caulk port 115A and lower caulk port 115B may be identical. In other embodiments, upper caulk port 115A and lower caulk port 115B may not be identical. Upper caulk port 115A and lower caulk port 115B may comprise an opening through the surface of upper half tank 105A and lower half tank 105B, respectively. Upper caulk port 115A and lower caulk port 115B may be located between tank gasket 120 and baffle gasket 110 when wastewater management tank 100 is assembled. Upper caulk port 115A and lower caulk port 115B may extend from a surface of upper half tank 105A and lower half tank 105B, respectively, towards joint 125 between upper half tank 105A and lower half tank 105B. Upper caulk port 115A may comprise surface portion 130A and internal portion 135A. Surface portion 130A may extend from a surface of upper half tank 105A to internal portion 135A. Internal portion 135A may extend from surface portion 130A through upper half tank 105A towards joint 125. In some embodiments, as depicted in FIG. 1, surface portion 130A and internal portion 135A may be circular in shape. In other embodiments, surface portion 130A and internal portion 135A may be elliptical, square, polygonal, or any other shape. In some embodiments, as depicted in FIG. 1, a diameter of surface portion 130A may be larger than a diameter of internal portion 135A. In other embodiments, a diameter of surface portion 130A may be the same as or less than a diameter of internal portion 135A. In some embodiments, surface portion 130A may include threads configured to receive a screw-in cap. Lower caulk port 115B may comprise surface portion 130B and internal portion 135B. Surface portion 130B may correspond to surface portion 130A, as disclosed herein. Internal portion 135B may correspond to internal portion 135A, as disclosed herein.

In some embodiments, as depicted in FIG. 1, when wastewater management tank 100 is initially assembled, upper caulk port 115A and lower caulk port 115B may not extend all the way through each of upper half tank 105A and lower half tank 105B to joint 125. In some embodiments, upper caulk port 115A and lower caulk port 115B may not be identical. In such embodiments, upper caulk port 115A may extend all the way through upper half tank 105A to joint 125 or lower caulk port 115B may extend all the way through lower half tank 105B to joint 125. In such an embodiment, either internal portion 135A of upper caulk port 115A or internal portion 135B of lower caulk port 115B may extend from surface portion 130A or surface portion 130B, respectively, to joint 125.

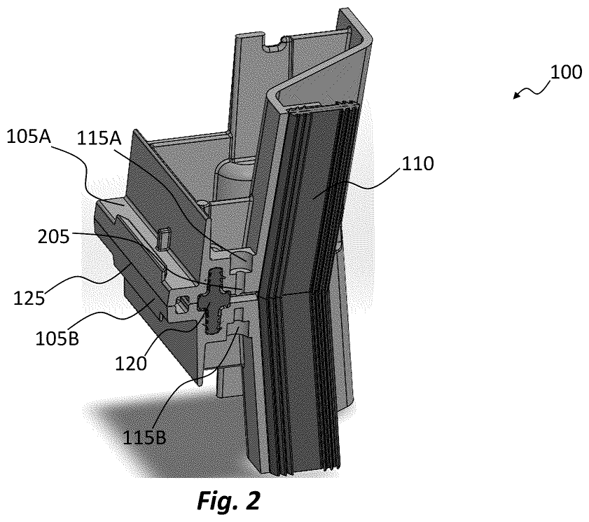

FIG. 2 depicts a section cut of wastewater management tank 100 with an open upper caulk port 115A. After a baffle (not shown) has been installed adjacent to baffle gasket 110 and upper half tank 105A and lower half tank 105B have been mated at joint 125, hole 205 may be drilled through upper caulk port 115A. In other embodiments, hole 205 may be drilled through upper caulk port 115A prior to assembling wastewater management tank 100. When drilled through upper caulk port 115A, hole 205 may create an opening from a surface of upper half tank 105A through upper half tank 105A to joint 125 between upper half tank 105A and lower half tank 105B. Hole 205 may allow an opening accessible from the surface of upper half tank 105A to joint 125 through which caulk or other sealant material may be applied. Although FIG. 2 depicts hole 205 drilled through upper caulk port 115A, hole 205 may alternatively be drilled through lower caulk port 115B. In other embodiments, upper caulk port 115A or lower caulk port 115B may include an opening to joint 125, and a hole through upper caulk port 115A or lower caulk port 115B may not need to be drilled.

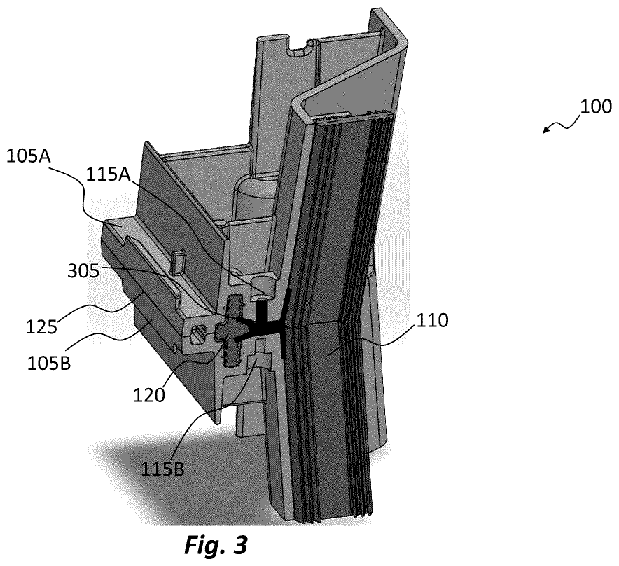

FIG. 3 depicts a section cut of wastewater management tank 100 with caulk 305 applied through upper caulk port 115A. After drilling hole 205 (as depicted in FIG. 2) through upper caulk port 115A, caulk 305 may be applied through hole 205. Because hole 205 extends through the surface of upper half tank 105A to joint 125, caulk 305 may be cleanly and evenly applied within joint 125. As caulk 305 is applied through opening 205, caulk 305 may spread between joint 125 and between tank gasket 120 and baffle gasket 110. Caulk 305 may be applied evenly, cleanly, and consistently between joint 125, tank gasket 120, and baffle gasket 110 to provide a more reliable watertight seal between joint 125, tank gasket 120, and baffle gasket 110. After caulk 305 has been applied through upper caulk port 115A, a cap (not shown) may be placed within the opening of upper caulk port 115A to prevent dirt, debris, or other material from entering upper caulk port 115A. In some embodiments, upper caulk port 115A may include threads, which may be configured to receive a screw-in cap. In other embodiments, a cap may not be installed in upper caulk port 115A, and upper caulk port 115A may be left open. Although FIG. 2 depicts caulk 305 applied through upper caulk port 115A, caulk may be applied through lower caulk port 115B if a hole is drilled through lower caulk port 115B.

The foregoing description has been presented for purposes of illustration. It is not exhaustive and is not limited to precise forms or embodiments disclosed. Modifications and adaptations of the embodiments will be apparent from consideration of the specification and practice of the disclosed embodiments. For example, while certain components have been described as being coupled to one another, such components may be integrated with one another or distributed in any suitable fashion.

Moreover, while illustrative embodiments have been described herein, the scope includes any and all embodiments having equivalent elements, modifications, omissions, combinations (e.g., of aspects across various embodiments), adaptations and/or alterations based on the present disclosure. The elements in the claims are to be interpreted broadly based on the language employed in the claims and not limited to examples described in the present specification or during the prosecution of the application, which examples are to be construed as nonexclusive. Further, the steps of the disclosed methods can be modified in any manner, including reordering steps and/or inserting or deleting steps.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Words such as “and” or “or” mean “and/or” unless specifically directed otherwise. Further, since numerous modifications and variations will readily occur from studying the present disclosure, it is not desired to limit the disclosure to the exact construction and operation illustrated and described, and, accordingly, all suitable modifications and equivalents may be resorted to, falling within the scope of the disclosure.

Other embodiments will be apparent from consideration of the specification and practice of the embodiments disclosed herein. It is intended that the specification and examples be considered as example only, with a true scope and spirit of the disclosed embodiments being indicated by the following claims.

What is claimed is:

1. A tank comprising:
an upper half tank comprising an upper caulk port and a lower half tank comprising a lower caulk port, wherein the upper half tank and the lower half tank are mated at a joint;
a baffle gasket located at an inner wall of the upper half tank and an inner wall of the lower half tank;
a tank gasket located at the joint between the upper half tank and the lower half tank; and
wherein the upper caulk port is configured to receive a sealant to seal the baffle gasket and the tank gasket.

2. The tank of claim 1, wherein the upper caulk port comprises a surface portion and an internal portion, wherein the surface portion extends from a surface of the upper half tank to the internal portion.

3. The tank of claim 2, wherein the surface portion and the internal portion are circular.

4. The tank of claim 2, wherein the surface portion includes threads configured to receive a screw-in cap.

5. The tank of claim 3, wherein a diameter of the surface portion is larger than a diameter of the internal portion.

6. The tank of claim 1, wherein the upper caulk port is located between the baffle gasket and the tank gasket.

7. The tank of claim 1, wherein the upper caulk port and the lower caulk port are identical.

8. The tank of claim 1, wherein the lower caulk port is configured to receive a sealant to seal the baffle gasket and the tank gasket.

9. The tank of claim 1, wherein the upper half tank and the lower half tank are identical.

10. The tank of claim 1, wherein the upper half tank and the lower half tank are formed from polypropylene or polyethylene.

11. The tank of claim 1, wherein the tank further comprises a baffle installed between the upper half tank and the lower half tank to divide the tank into a first chamber and a second chamber.

12. A tank comprising:
an upper half tank comprising a caulk port and a lower half tank, wherein the upper half tank and the lower half tank are mated at a joint;
a baffle gasket located at an inner wall of the upper half tank and an inner wall of the lower half tank;
a tank gasket located at the joint between the upper half tank and the lower half tank; and
wherein the caulk port is configured to receive a sealant to seal the baffle gasket and the tank gasket.

13. The tank of claim 12, wherein the caulk port comprises a surface portion and an internal portion, wherein the surface portion extends from a surface of the upper half tank to the internal portion.

14. The tank of claim 13, wherein the surface portion and the internal portion are circular.

15. The tank of claim 13, wherein the surface portion includes threads configured to receive a screw-in cap.

16. The tank of claim 14, wherein a diameter of the surface portion is larger than a diameter of the internal portion.

17. The tank of claim 12, wherein the caulk port is located between the baffle gasket and the tank gasket.

18. The tank of claim 12, wherein the upper half tank and the lower half tank are formed from polypropylene or polyethylene.

19. The tank of claim 12, wherein the tank further comprises a baffle installed between the upper half tank and the lower half tank to divide the tank into a first chamber and a second chamber.

20. A method of installing a tank, comprising:
placing an upper half tank comprising a caulk port on a lower half tank, wherein:
the upper half tank and the lower half tank are mated at a joint;
a baffle gasket is located at an inner wall of the upper half tank and an inner wall of the lower half tank;
a tank gasket is located at the joint between the upper half tank and the lower half tank;
drilling a hole through the caulk port; and
applying a sealant through the caulk port to seal the baffle gasket and the tank gasket.
